(19) United States
(12) Patent Application Publication
(10) Pub. No.: US 2011/0119130 A1
(43) Pub. Date: May 19, 2011

(54) METHODS, SYSTEMS, AND APPARATUS TO MANAGE MEAL PLANNING AND COUPON DISPENSING

(76) Inventors: Thomas E. Agan, Northbrook, IL (US); Jennifer L. Sweene, Lake Villa, IL (US); Kristen Ellen Sanok, Hoboken, NJ (US); Christopher LeClair, Chicago, IL (US)

(21) Appl. No.: 12/833,742

(22) Filed: Jul. 9, 2010

Related U.S. Application Data
(60) Provisional application No. 61/224,536, filed on Jul. 10, 2009.

(51) Int. Cl. G06Q 30/00; G06F 17/30

(52) U.S. Cl. 705/14.49; 707/769; 707/E17.014

(57) ABSTRACT

Methods, systems, and apparatus to manage meal planning and coupon dispensing are disclosed. An example method includes parsing a message posted on a social networking service to extract a keyword by determining which of a plurality of entries relates to food; querying a recipe service using the keyword as an ingredient to produce a first set of recipes including the ingredient; comparing each of the first set of recipes to a profile corresponding to a consumer associated with the message to produce a second set of recipes customized to the consumer; and conveying at least a first one of the second set of recipes to the consumer.

### RELATED APPLICATION

This patent claims the benefit of U.S. Provisional Patent Application Ser. No. 61/224,536, filed on Jul. 10, 2009, which is hereby incorporated herein in its entirety.

### FIELD OF THE DISCLOSURE

This disclosure relates generally to market research and, more particularly, to methods, systems, and apparatus to manage meal planning and coupon dispensing.

### BRIEF DESCRIPTION OF THE DRAWINGS

FIG. 1 is a schematic illustration of an example system to manage meal planning and coupon dispensing constructed in accordance with the teachings of this disclosure.

FIG. 2 is a schematic illustration of an example portal that operates with the example system of FIG. 1.

FIG. 3 is a schematic illustration of the example foodspace manager shown in FIG. 1.

FIG. 4 is an example profile influence diagram constructed in accordance with the teachings of this disclosure.

FIG. 5 is an example consumer profile table to be used with the example foodspace manager shown in FIGS. 1 and 3.

FIGS. 6 and 7 are flowcharts representative of example machine readable instructions that may be executed by, for example, the example foodspace manager shown in FIGS. 1 and 3.

FIG. 8 is a schematic illustration of an example processor platform that may execute the instructions of FIGS. 6 and 7 to implement any or all of the example methods, systems, and apparatus described herein.

### DETAILED DESCRIPTION

Although the following discloses example methods and apparatus including, among other components, software executed on hardware, it should be noted that such methods and apparatus are merely illustrative and should not be considered as limiting. For example, it is contemplated that any or all of these hardware and software components could be embodied exclusively in hardware, exclusively in software, exclusively in firmware, or in any combination of hardware, software, and/or firmware. Accordingly, while the following describes example methods and apparatus, such examples are provided are not the only way to implement the methods and apparatus described herein.

Generally, the example methods, systems, and apparatus described herein enable one or more consumers to receive candidate recipes of interest, candidate shopping locations for the consumer(s), and/or candidate promotions for food products. To provide such information and/or services, the example methods, systems, and/or apparatus described herein monitor one or more social networking services to obtain information related to the consumers. For example, consumers may use social networking services to discuss potential meals and/or meal plans. The example methods, systems, and apparatus described herein are capable of extracting data from the monitored social networking service, such as a keyword associated with an ingredient, and using the extracted data to suggest one or more recipes or meals for the consumer. In some instances, the consumer may provide the example systems and/or apparatus described herein with additional information to be used in the determination of suggested recipes via a direct input on, for example, a portal of an interface implemented on a wireless device or a personal computer.

To provide suggestions and/or other information customized to individual consumers or households, the example methods, systems, and/or apparatus described herein evaluate food purchasing behaviors of the consumers based on food attributes (e.g., flavors, styles, ingredients, etc. of purchased food) to generate a characteristic profile for each consumer. The characteristic profile corresponding to a consumer can be compared to contents of a recipe database to identify recipes the consumer is likely to enjoy. The example methods, systems, and/or apparatus described herein can also present the consumer with one or more candidate recipes, one or more coupons (e.g., coupons related to the candidate recipe(s)), and/or one or more purchase locations (e.g., purchase locations related to the candidate recipe(s) and/or the coupon(s)) that have attributes that match the consumer's characteristic profile. While the example methods, systems, and apparatus described herein relate to food, such examples are not limited thereto. For example, the systems, methods, and/or apparatus described herein may apply to retail shopping, one or more shopping categories (e.g., baby products, golf, etc.), entertainment (e.g., movies, shows, theater, etc.), travel, etc.

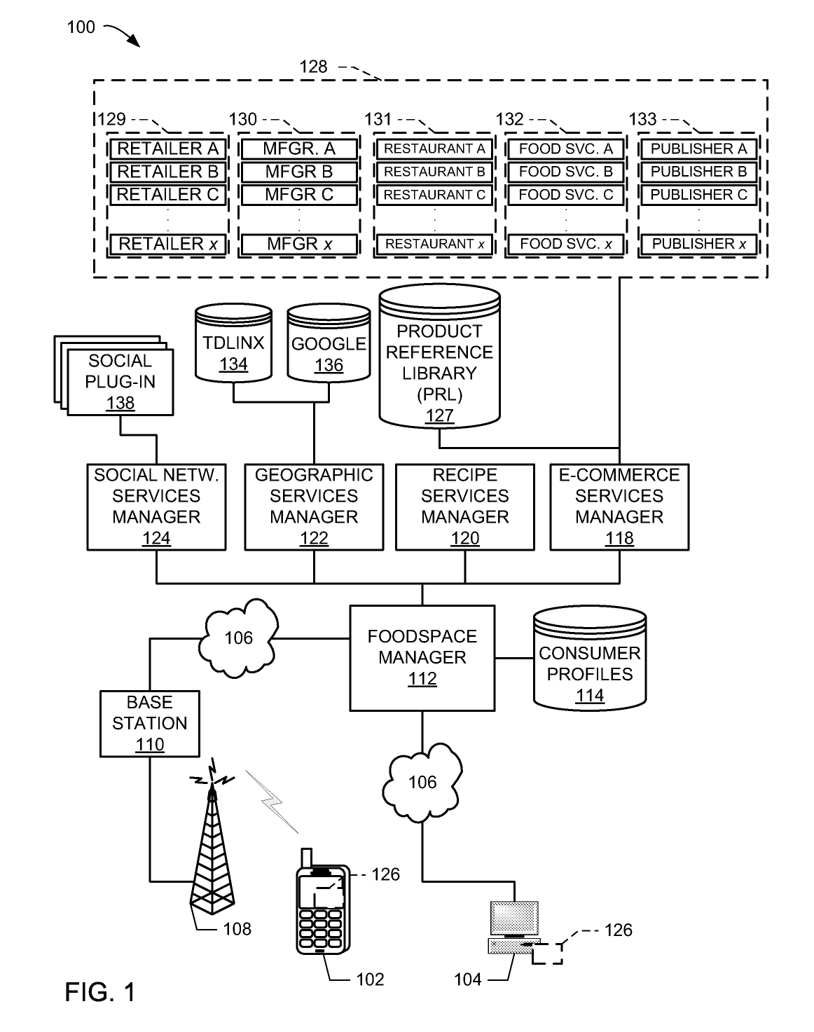

FIG. 1 is a schematic illustration of an example meal planning and coupon dispensing system 100. The example meal planning and coupon dispensing system 100 of FIG. 1 receives consumer input via a wireless device, such as a wireless telephone 102 (e.g., an iPhone®, a Blackberry®, etc.) and/or via a networked device, such as a personal computer 104 (PC) (e.g., PC, Mac, Unix, etc.) via, for example, a network 106 (e.g., an intranet and/or Internet connection). For circumstances in which the consumer provides input via the wireless telephone 102, such telephone and/or data signals containing the input may be received by a wireless transceiver tower 108 communicatively connected to a base station 110 to facilitate communication to/from the consumer and a wireless carrier (e.g., a wireless service provider).

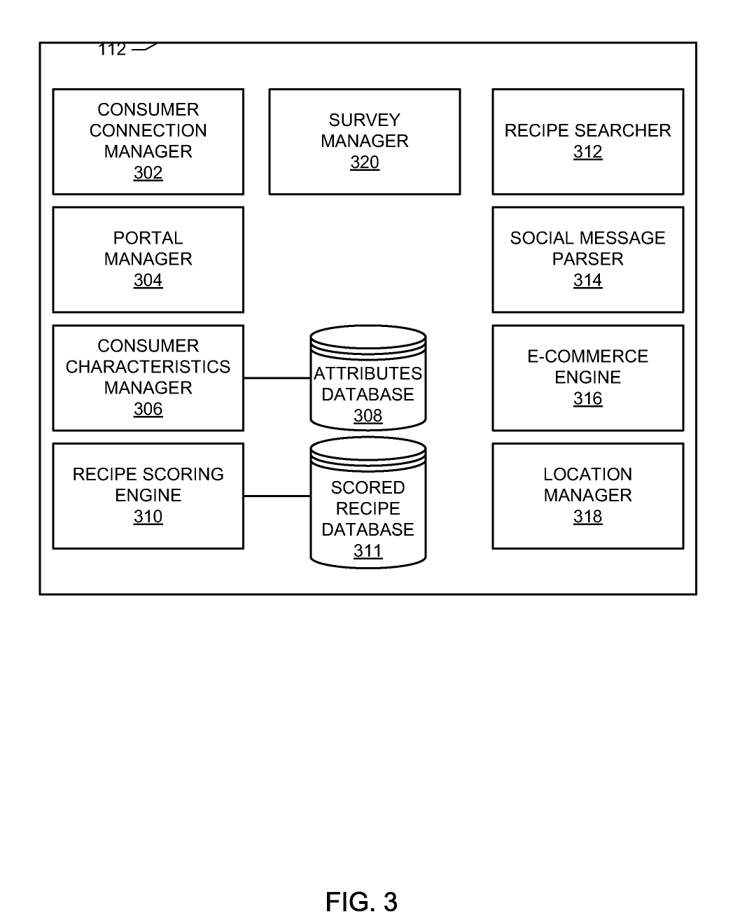

In the illustrated example of FIG. 1, the wireless telephone 102 and the PC 104 include an example consumer interface 126. The example consumer interface 126 may operate on any device (e.g., the example wireless telephone 102, the example PC 104, etc.) to facilitate exchanges of information between the consumer using the interface 126 and an example foodspace manager 112, which is described in detail below in connection with FIG. 3. Generally, the example foodspace manager 112 of FIG. 1 processes one or more consumer input(s) in view of consumer profiles stored in a consumer profile database 114, and provides electronic commerce (e-commerce) services via an e-commerce services manager 118, recipe services via a recipe services manager 120, geographic services via a geographic services manager 122, and/or social networking services via a social networking services manager 124. The consumer interface 126 obtains information to be used by the example foodspace manager 112 by, for example, causing a device (e.g., the wireless device 102 and/or the PC 104) to display a portal interface including a list of foodspace friends, query fields for food and/or recipe searches, candidate recipe display fields, and/or promotions offered by food product manufacturers and/or retailers. The example foodspace manager 112 uses the information received by the portal to provide one or more of the example services described herein.

The example consumer interface 126 may also receive direct queries from the consumer and, in response, conveys the corresponding query information to the foodspace manager 112 for processing. For example, a consumer may enter an ingredient via the example consumer interface 126 in an effort to identify one or more recipes that include the entered ingredient (e.g., a favorite ingredient, a currently owned ingredient that should be used before expiration, etc.), which is sometimes referred to herein as a seed ingredient. In some examples, the consumer may enter more than one seed ingredient. In response to receiving the seed ingredient from the consumer interface 126, the example foodspace manager 112 employs one or more services to identify one or more recipes likely to be of interest to the consumer. In the illustrated example, the foodspace manager 112 accesses the recipe services manager 120 to retrieve candidate recipes that include the seed ingredient. The example recipe services manager 120 may return a plurality of candidate recipes that include the seed ingredient (e.g., chicken) from one or more databases (not shown) using any suitable query device(s) and/or method(s).

To narrow the results returned by the recipe services manager 120, the example foodspace manager 112 of FIG. 1 accesses the consumer profiles database 114 to compare the candidate recipes to a consumer characteristic profile associated with the consumer that entered the seed ingredient. In particular, the example foodspace manager 112 compares attribute(s) of the candidate recipes to attributes of the retrieved consumer characteristic profile. Example attributes that the foodspace manager 112 attempts to match between the candidate recipes and the consumer characteristic profile include other recipe ingredients the consumer is believed to prefer and/or use frequently, recipe ethnicity types the consumer is believed to prefer and/or use frequently, a degree of spiciness that the consumer is believed to prefer and/or use frequently, a degree of recipe difficulty that the consumer is believed to be capable of or prefer making, food allergies, medical conditions (e.g., diabetes, lactose intolerance, Celiar disease, etc.), a preparation time that the consumer prefers not to exceed, and/or a recipe dish-type (e.g., a grilling recipe, a baking recipe, a stir-fry recipe, etc.) that the consumer is believed to prefer and/or make frequently, etc.

As described in further detail below, the example consumer characteristic profiles of the consumer characteristic profiles database 114 of FIG. 1 include weighted attributes. The attributes may be aggregated to define a characteristic profile of each consumer, in which the attributes include descriptive qualities of food, food types, food ethnicity, etc. Example attributes include, but are not limited to a spiciness weight, a sweetness weight, a fruit weight and/or corresponding weights for specific fruits, a vegetable weight and/or corresponding weights for specific vegetables, a meat weight, a lifestyle weight (e.g., based on general fitness, sports activities, recreational activities, etc.) etc. For example, any of the candidate recipes returned by the recipe services manager 120 based on the received seed ingredient may include a spiciness attribute indicative of a relatively high degree of spiciness. In the event that the consumer characteristic profile is indicative of a relatively bland pallet with respect to spiciness, the example foodspace manager 112 eliminates one or more candidate recipes that exceed a spiciness weight. Thus, the subset of candidate recipes presented to the consumer in response to the entrance of the seed ingredient into the interface 126 better reflect the preferences of the consumer.

In the illustrated example of FIG. 1, the example foodspace manager 112 may also employ the e-commerce services manager 118 in response to a query entered into the consumer interface 126. In the illustrated example, the e-commerce services manager 118 identifies, for example, one or more specific products of interest, manufacturers offering promotions for the product of interest, retailers offering promotions for the product of interest, restaurants featuring ingredient(s) of interest, food services (e.g., at-home delivery services (PeaPod®, Schwan's®, etc.)) offering promotions associated with ingredients of interest, and/or publisher(s) (e.g., Zagat®) associated with ingredients of interest, ethnic foods of interest, food categories of interest, and/or restaurant reviews. In the illustrated example of FIG. 1, the e-commerce services manager 118 is communicatively connected to a product reference library (PRL) 127. For example, the Nielsen Company maintains a PRL that codes more than 700,000 items, in which each item includes a number of descriptive characteristics (e.g., an average of forty characteristics). The characteristics for each item may include, but are not limited to, manufacturer name, product size, brand, flavor, lot number, serial number, package type, and/or nutritional information. Additionally, the PRL 127 also includes the associated UPC for the product assist in product identification because many products sold by manufacturers have several permutations of size, quantity, color schemes, and/or packaging shapes that may make pinpoint identification difficult.

Additionally, the example e-commerce service manager 118 may be communicatively connected to one or more third party clients 128. While both consumers and third party clients 128 may be users of the example system 100, the example third party clients 128 are generally organizations, corporations and/or businesses associated with commerce. In the illustrated example of FIG. 1, the third party 128 clients include one or more retailers (e.g., grocery stores) 129, one or more manufacturers 130, one or more restaurants (e.g., fast-food, sit-down, fine dining, etc.) 131, one or more food services organizations (e.g., PeaPod®, Dinner By Design®) 132, and/or one or more publishing entities (e.g., Food Network®, Martha Stewart®, etc.) 133. The example third party clients 128 may be included as participants in the example system 100 of FIG. 1 based on payment of subscription fees, and may justify payment of the subscription fees based on one or more opportunities to present advertisements to the consumer via the portal of the interface 126, to offer the consumer promotional incentives to shop at a particular store and/or purchase a particular product, and/or to generally gain exposure to the consumer in an effort to establish brand awareness and/or brand loyalty. In some examples, the advertisements, incentive offers, etc. may be provided to the consumer via the portal of the interface 126 based at least in part on a location of the consumer and/or the wireless device 102.

In the illustrated example of FIG. 1, the foodspace manager 112 may also employ the geographic services manager 122 in response to a consumer query entered into the consumer interface 126. The example geographic services manager 122 includes one or more in-house and/or third-party geographic utilities/services to allow the consumer to determine where products of interest may be purchased. For instance, the Nielsen Company categorizes merchants (e.g., retailers and/or wholesalers) and/or compiles data related to characteristics of stores via its TDLinx® system 134. In the TDLinx° system 134, data is tracked and stored that is related to, in part, a merchant store parent company, the parent company marketing group(s), the number of store(s) in operation, the number of employee(s) per store, the geographic address and/or phone number of the store(s), and the channel(s) serviced by the store(s). Channels may include supermarkets, convenience stores, drug stores, mass merchandisers, and/or liquor stores. For each retailer in the TDLinx® system, a contact phone number, e-mail address(es), web-page address(es), street address, latitude, and/or longitude is available to permit efficient contact and location. Additionally or alternatively, the example geographic services manager 122 may employ mapping services from any other available geographic-based service, such as the geographic services provided by Google® 136. Such mapping services may return driving directions and/or visual maps to allow the consumer to locate and/or travel to one or more locations that have the food product(s) of interest.

In the illustrated example of FIG. 1, the foodspace manager 112 may also employ the social networking services manager 124 to enable consumers to communicate to plan a meal of interest. The example social networking services manager 124 may be a stand alone service, a custom service, and/or may employ a social plug-in 138 to operate with one or more social networking applications with which the consumer participates. Social networking applications may include, but are not limited to Facebook®, MySpace®, Twitter®, and Orkut®. For example, in the event that the consumer is a participant on Facebook®, the example social plug-in 138 may be a javascript application associated with the consumer's Facebook® account. Communication associated with the consumer in the Facebook® application may be monitored and/or parsed by the example social plug-in 138 and provided to the foodspace manager 112. For example, if the consumer is communicating with one or more friends and/or family members about dinner plans, a dinner party, and/or other food-related planning via one or more social networking services, the example social plug-in 138 may identify keywords in the one or more communications related to food. Such keywords may be parsed by the example social plug-in 138 and/or the foodspace manager 112, and then automatically submitted as a query to, for example, the geographic services manager 122 to identify candidate locations where the product can be found. Without limitation, the example foodspace manager 112 may, additionally or alternatively, automatically submit a query to the recipe services manager 120 to identify one or more candidate recipes based on the keywords parsed by the social plug-in 138. Further, the example foodspace manager 112 may automatically submit a query to the e-commerce services manager 118 to identify one or more third party clients 128 that sell a product of interest and/or provide a service of interest (e.g., at-home grocery delivery, restaurant reviews, etc.) related to the candidate recipe identified by the keyword and/or based on the keywords entered. Responses from the one or more queries to the one or more service managers 118, 120, and/or 122 may be presented via a portal and/or other user interface 126. In operation, the consumer will be presented with options and/or advertisements in real time or substantially real time as the conversation occurs in the social networking application. The consumer may, for example, use this information to make one or more suggestions to a social group associated with the social networking service from which the keyword(s) were extracted. As an ongoing discussion continues on the social networking site or service, the example foodspace manager 112 can continue to extract data related to food and to process the data as described herein to provide suggested recipes, coupons, locations, etc.

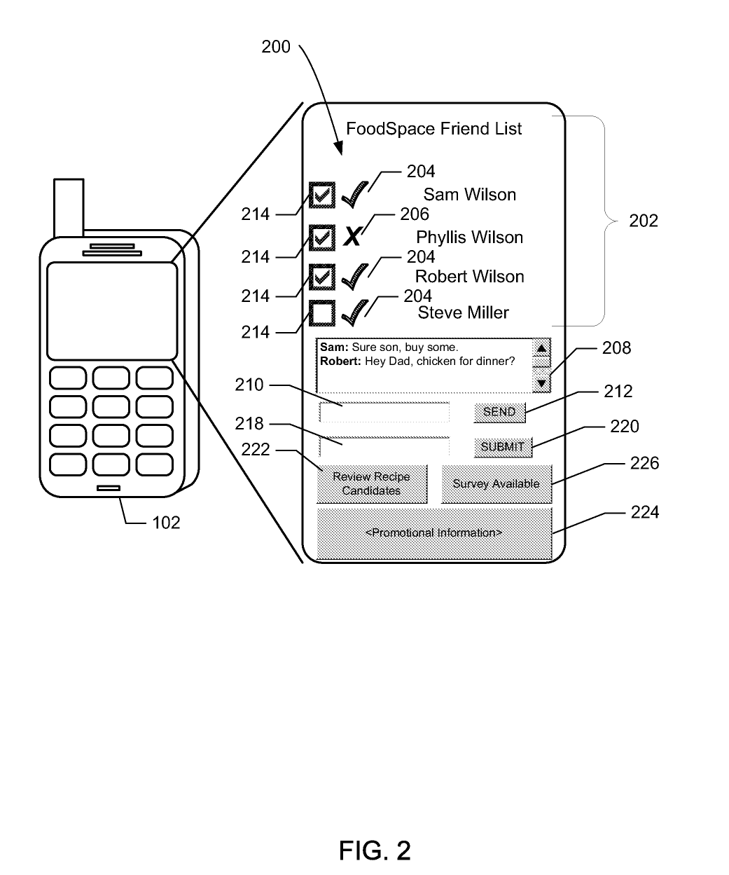

Furthermore, as described in detail below in connection with FIG. 2, the keyword(s) extracted from the social networking service may be supplemented with queries or data received directly from the consumer. That is, the example foodspace manager 112 can combine information extracted from a social networking site with information received directly from the consumer and, in some examples, may submitted the combined data to the one or more service managers 118, 120, and/or 122 as described above.

Additionally or alternatively, the social networking services manager 124 and/or the consumer interface 126 may cooperate to provide a social networking application that facilitates and/or enables communication between any number of friends and/or family members. In the illustrated example of FIG. 2 a consumer portal 200 is displayed on the example wireless telephone 102. While the methods and apparatus described herein include the example portal 200 on the wireless telephone 102, the example portal 200 may also, without limitation, be displayed on any other networked device, such as the example PC 104. The example portal 200 of FIG. 2 includes a friend list 202 in which each friend includes an on-line status indicator (e.g., a check-mark) 204 or an off-line status indicator (e.g., an “x”) 206. Messages from each friend may be displayed in a message box 208. The consumer may send messages using a message field 210 and may select a send button 212 to send a message to all members selected via a member selection box 214. In the event that the consumer wishes to send a message to a subset of consumers (e.g., family members only), the example member selection box 214 of the person(s) to be omitted from the communication may be set by the consumer in an unchecked state, such as the unchecked member selection box 214 associated with Steve Miller in FIG. 2.

In the illustrated example of FIG. 2, the portal 200 provides the consumer with a query field 218 and a corresponding submit query button 220. In response to submitted queries by the consumer, and/or in response to keywords extracted by the consumer interface 126 from the example message box 208, recipe candidates are made available to the consumer via a review recipe candidates button 222. In the event that the consumer selects the review recipe candidates button 222, one or more alternate display screens (not shown) may be displayed via the example portal 200 containing details of the recipes. Additionally, in response to submitted queries by the consumer, and/or in response to keywords extracted by the consumer interface 126 from the example message box 208, one or more advertisements, retailer promotions, and/or manufacturer promotions (e.g., coupons) 224 are displayed on the example portal 200. As described above, the one or more promotions 224 (e.g., promotions by the manufacturer, retailer, specialty store, etc.) and/or candidate recipes may be the result of data provided by the example e-commerce services manager 118 and/or the example recipe services manager 120. Additionally, any geographic information (e.g., a location information associated with items presented in associated with the promotional information 224) may be provided by way of data provided by the example geographic services manager 122.

The example portal 200 of FIG. 2 also includes a survey button 226 that allows the consumer to initiate one or more surveys. Survey content may be based on, in part, known consumer attributes/preferences, consumer demographics, current consumer location (e.g., via global positioning system (GPS) functionality of the example wireless telephone 102, via Internet-based location information, via consumer supplied location information, via wireless device cell tower triangulation, etc.), time-of-day, and/or season of year. Without limitation, consumers may be provided with one or more incentives to participate in the survey(s). In the event that the consumer is near a shopping mall (e.g., as determined by GPS), the systems, methods, and/or apparatus described herein may tailor a survey for the consumer based on the identified location and/or one or more characteristics of the consumer. For example, if the consumer is a diabetic, the example foodspace manager 112 may tailor one or more surveys to determine consumer eating habits in view of his/her diabetic condition, and offer one or more promotions (e.g., coupons) for one or more proximate retailers and/or manufacturer products nearby. In another example, the example foodspace manager 112 may invoke one or more promotions via the promotion section 224 of the example portal 200 associated with proximate retailers, specialty stores, manufacturer products, and/or services based on a frequency of visits to that general vicinity.

FIG. 3 is a schematic illustration of the example foodspace manager 112 of FIG. 1. The example foodspace manager 112 includes a consumer connection manager 302, a portal manager 304, a consumer characteristics manager 306 coupled to an attributes database 308, and a recipe scoring engine 310 coupled to a scored recipe database 311. The example foodspace manager 112 also includes a recipe searcher 312, a social message parser 314, an e-commerce engine 316, a location manager 318, and a survey manager 320. The example connection manager 302 manages connections with each running instance of the consumer interface 126 associated with a communication device, such as the example wireless telephone 102 and/or the example PC 104. Additionally, the example connection manager 302 manages connection(s) with each running social plug-in 138 associated with a consumer so that any messages obtained from communication in the social application can be associated with and/or attributed to the respective consumer and/or one or more friends of the consumer (e.g., of the friend list 202). Without limitation, the example social plug-in 138 may operate on the example foodspace manager 112, the example wireless device 102, and/or the example PC 104. For example, the example social plug-in 138, when operating on the example wireless device 102, may monitor for social messaging activity, text messages, e-mail messages, and/or voice communication. In response to such communication, keywords may be extracted and forwarded to the example foodspace manager 112.

The example portal manager 304 generates a layout for the example portal 200 displayed on the wireless telephone 102 and/or the PC 104. In some circumstances, the example portal manager 304 detects when the consumer is accessing one or more services of the foodspace manager 112 via a mobile device, such as the example wireless telephone 102, and generates a portal layout for the corresponding device. In other circumstances, the example portal manager 304 detects when the consumer is accessing one or more services of the foodspace manager 112 via the PC 104, and generates a portal 200 layout for the PC 104. Without limitation, the example portal manager 304 may be implemented as one or more web servers for each networked device.

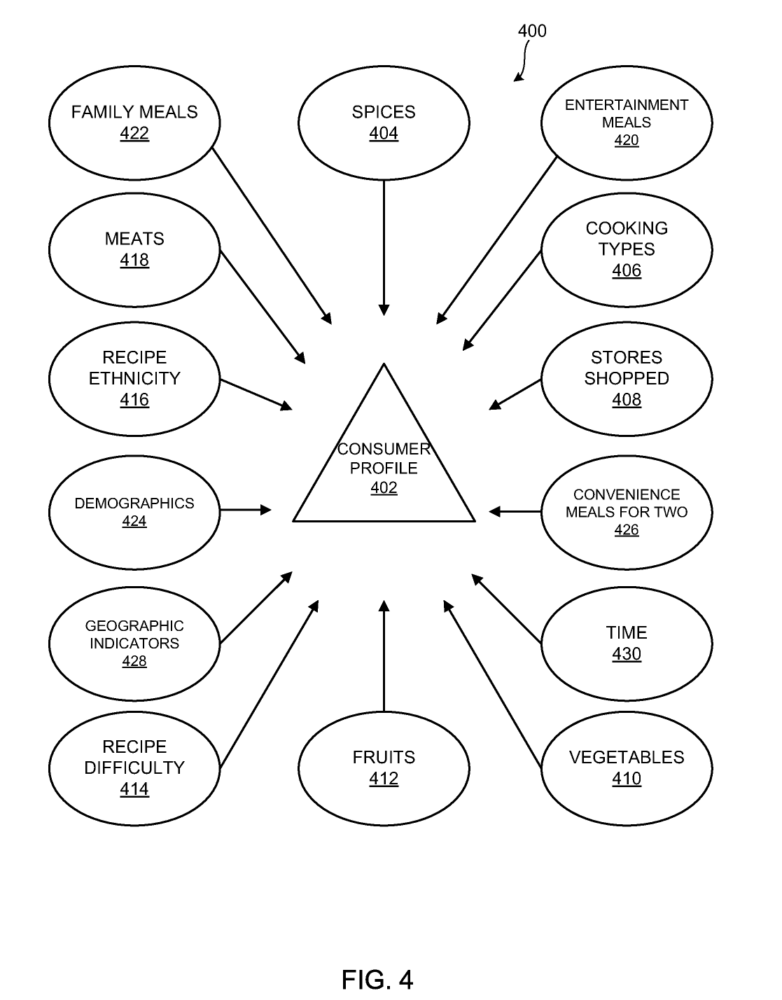

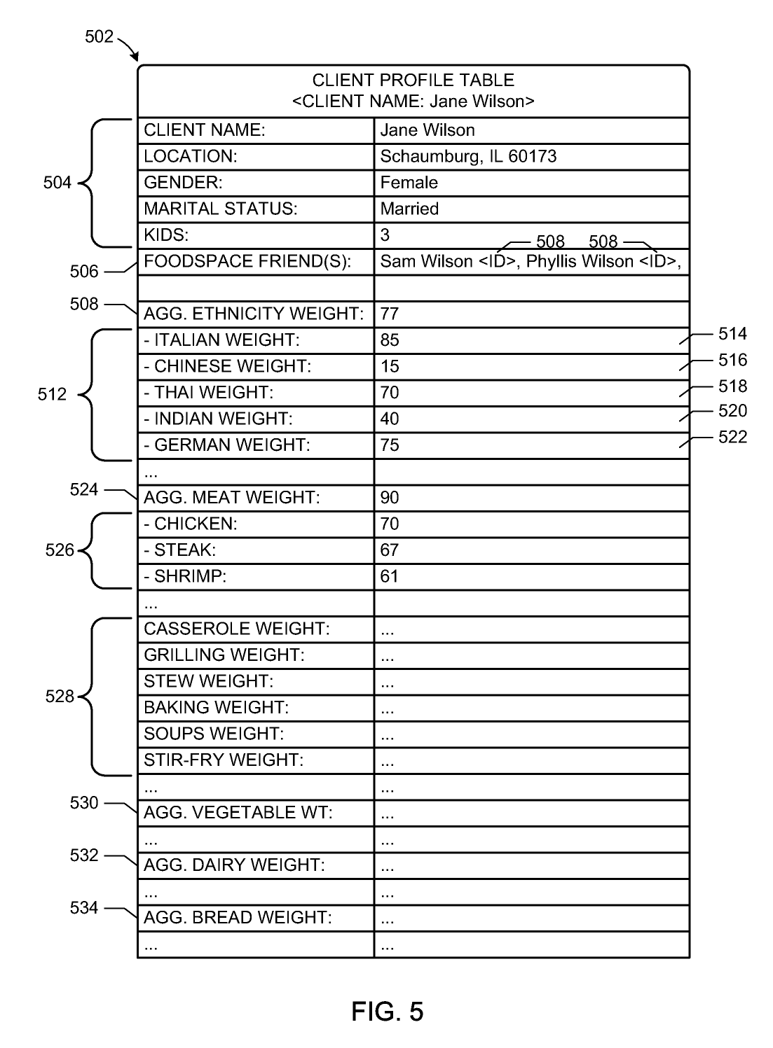

The example consumer characteristics manager 306 maintains the attributes database 308 to allow one or more attributes to be considered when evaluating consumer food preferences and corresponding recipe candidates. Each candidate recipe may include any number of corresponding attributes, and each of the corresponding attributes may be assigned a score based on consumer preferences. Additionally, the example consumer characteristics manager 306 determines one or more consumer preferences based on received surveys and/or observed consumer behaviors. For example, the example consumer characteristics manager 306 monitors each consumer via submitted queries for preferred food items, parsed food-related messages shared in the example portal 200 between friends 202, and/or parsed food-related messages shared in one or more social networking services (e.g., Facebook®, LinkedIn®, MySpace®, etc.) that are captured by the example social plug-in 138 and forwarded to the foodspace manager 112. As described in further detail below in connection with FIGS. 4 and 5, the example consumer characteristics manager 306 generates a consumer profile for each consumer and stores each consumer profile in a consumer profile table stored in the consumer profiles database 114.

The example recipe scoring engine 310 parses each recipe identified by and/or otherwise received by the example recipe services manager 120 for any number of attributes. Based on the attributes identified in each recipe, the example recipe scoring engine 310 characterizes the recipe for future reference and/or comparison to one or more consumer profiles. For example, a lasagna recipe received by the recipe scoring engine 310 is parsed to identify ingredients typically associated with Italian cooking, thereby allowing the scoring engine 310 to associate the recipe as having an Italian ethnicity characteristic. Additionally, the scoring engine 310 identifies one or more spices used in the example lasagna recipe to identify a spiciness characteristic that is relatively low when compared to, for example, a chicken biryani recipe having chili spices and chili peppers. After any recipe has been scored by the example scoring engine 310, it may be saved for future consideration as a recipe candidate in the scored recipe database 311.

The example recipe searcher 312 retrieves one or more recipes from the recipe services manager 120 that may match consumer characteristics. Additionally or alternatively, the example recipe searcher 312 may perform periodic, aperiodic, and/or scheduled searches of known food websites for new recipes to forward to the example recipe scoring engine 310. As additional recipes are identified and subsequently scored, the scored recipe database 311 grows to provide the consumer with a greater number of candidate recipes from which to choose.

The example social message parser 314 is communicatively coupled to one or more social networking services (e.g., Facebook) via the example social plug-in 138. When the example social plug-in 138 forwards one or more messages from the consumer and/or from one or more of the consumer's friends, the example social message parser 314 parses the one or more communications for keywords associated with food, cooking, dinner, parties, etc. Such keywords may be pre-defined in a cooking terms lexicon (e.g., a dictionary). Even when the consumer has not yet decided upon final dinner arrangements (e.g., which ingredients to use, which ethnic food-type to prepare, which recipe to use, etc.), the parsing activities performed by the example social message parser 314 enable real-time or substantially real-time input of ideas to help the consumer decide by way of dynamic advertisements to be presented in the portal 200 via the example promotions message box 224. Additionally, the example social message parser 314 invokes the e-commerce engine 316 to identify one or more manufacturers and/or retailers that have one or more food products of interest. The manufacturers and/or retailers may dynamically generate promotions in response to receiving a query with the knowledge that the consumer will be timely presented with many possible choices to purchase one or more products of interest. Similarly, the social message parser 314 may invoke the example location manager 318 to identify where such available products of interest may be located.

The example survey manager 320 invokes one or more surveys to be presented to the consumer via the example portal 200. In operation, the survey manager 320 may be invoked based on, for example, one or more trigger profiles. An example trigger profile may include, but is not limited to one or more current conditions of the consumer (e.g., current location), one or more characteristics of the consumer (e.g., medical conditions, sports enthusiast, etc.), demographics (e.g., age, sex, race, income, etc.), a time-of-day, and/or a season of year. The example trigger profile(s) may include any combination of the aforementioned current conditions, characteristics, demographics, time-of-day, and/or season of year to initiate the one or more surveys.

Without limitation, the example survey manager 320 may be communicatively coupled to the example e-commerce engine 316 to identify one or more promotions that may be available from retailers, manufacturers, publishers, restaurants, and/or food service organizations/businesses. In one example, the system 100 may be utilized in connection with one or more interest groups relevant to the consumer and/or one or more characteristics of the consumer. Relevant interest groups may include, but are not limited to Weight Watchers® (e.g., for consumers having attributes indicative of weight loss efforts), the American Diabetes Association® (e.g., for consumers having attributes indicative of diabetic issues), and/or the American Heart Association® (e.g., for consumers having attributes indicative of high cholesterol).

FIG. 4 illustrates an example consumer profile influence diagram 400 that identifies any number of example attributes that converge to result in a consumer profile. In the illustrated example of FIG. 4, a consumer profile 402 may be the result of any number of influences and/or preferences that the consumer may have communicated (e.g., via survey) and/or consumer behaviors observed by the example foodspace manager 112. The example consumer profile 402 may be derived based on, but not limited to spice(s) preferences 404, cooking type preferences 406, favorite store preferences 408 and/or vegetable preferences 410. Additionally, the example consumer profile 402 may be derived based on fruit preferences 412, recipe difficulty preferences 414, recipe ethnicity preferences 416, and/or meat preferences 418. The example consumer profile 402 may also be derived based on attributes related to entertainment-type meals (e.g., parties, back-yard grilling parties, formal dining parties, etc.) 420, family-type meals (e.g., specific to small families without kids, larger families with kids, families with in-house elders, etc.) 422, demographic attributes (e.g., age, sex, marital status, profession, income, race, location, etc.) 424, and/or convenience-type meals (e.g., meals for two people in less than 30-minutes of preparation time) 426. Further, the example consumer profile 402 may be derived based on attributes related to geographic location 428, such as known seasonal food availabilities for a given region during a particular time attribute 430 (e.g., sweet-corn in Wisconsin in August, Rainer cherries in July in Oregon, etc.).

To identify and/or tailor each consumer's preferences with a sufficiently granular degree of resolution, the example consumer characteristics manager 306 of FIG. 3 generates, maintains, and/or updates a consumer profile table 502, as shown in FIG. 5. The example consumer profile table 502 of FIG. 5 may include any number of individual consumers and associated weighting values for each consumer. In the illustrated example of FIG. 5, the consumer profile table 502 includes general consumer information fields (e.g., demographic information) 504, and one or more fields to identify whether the consumer has foodspace friends via a friends field 506. The example friends field 506 may include any number of usernames and/or screen names associated with user and/or social networking sites, which may further be identified by a social networking site identifier 508 associated with each name.

Based on survey data provided by the consumer, observed consumer food purchasing behaviors, and/or based on recipes obtained by the consumer via the example foodspace manager 112, the example consumer characteristics manager 306 assigns the consumer a corresponding weighting value for any number of attributes. For example, the example consumer profile table 502 includes an aggregate ethnicity weight 510 to identify a relative degree of culinary curiosity. If the aggregate ethnicity weight 510 is relatively high (e.g., >70 out of 100), then the consumer has a corresponding high likelihood of trying other ethnic recipes that have not previously been attempted. On the other hand, if the aggregate ethnicity weight 510 is relatively low (e.g., <40), then the consumer is believed to prefer less ethnic variety and/or experimentation when deciding which recipes from which to choose.

While the example aggregate ethnicity weight 510 may indicate an overall willingness to experiment with other ethnic recipes, one or more weights may also be applied to the consumer in a more specific manner. For example, each consumer may also include a corresponding ethnic-specific weight 512, which may include any number of specific ethnicities. Ethnicities associated with recipes may include, but are not limited to an Italian weight 514, a Chinese weight 516, a That weight 518, an Indian weight 520, and/or a German weight 522.

The example consumer profile table 502 may include any number of generalized, aggregate, and/or specific food-related attributes to better characterize the consumer. Each weighted attribute value may be on a number scale from zero to 100 and/or any other scale capable of representing a relative likelihood of consumer preference toward any given attribute. Attributes may further include, but are not limited to an aggregate meat weight 524, specific meat weights 526, dish-type weights 528, vegetable weights 530, dairy weights 532, and/or bread weights 534. In operation, the example recipe searcher 312 compares one or more recipe candidates and/or one or more scored recipes stored in the example scored recipe database 311 to identify a match recipe based on the consumer profile, such as the example consumer profile table 502 of FIG. 5.

While the example meal planning and coupon dispensing system 100 has been illustrated in FIG. 1, one or more of the interfaces, data structures, elements, processes, GUIs, and/or devices illustrated in FIGS. 1-5 may be combined, divided, re-arranged, omitted, eliminated and/or implemented in any other way. Further, the example foodspace manager 112, the example consumer preferences database 114, the example e-commerce services manager 118, the example recipe services manager 120, the example geographic services manager 122, the example social networking services manager 124, the example consumer interface 126, the example product reference library 127, the example social plug-in 138, the example consumer connection manager 302, the example portal manager 304, the example consumer characteristics manager 306, the example attributes database 308, the example recipe scoring engine 310, the example scored recipe database 311, the example recipe searcher 312, the example social message parser 314, the example e-commerce engine 316, the example location manager 318, and/or the example consumer profile table 502 FIGS. 1-5 may be implemented by hardware, software, firmware and/or any combination of hardware, software and/or firmware. Thus, for example, any of the example foodspace manager 112, the example consumer preferences database 114, the example e-commerce services manager 118, the example recipe services manager 120, the example geographic services manager 122, the example social networking services manager 124, the example consumer interface 126, the example product reference library 127, the example social plug-in 138, the example consumer connection manager 302, the example portal manager 304, the example consumer characteristics manager 306, the example attributes database 308, the example recipe scoring engine 310, the example scored recipe database 311, the example recipe searcher 312, the example social message parser 314, the example e-commerce engine 316, the example location manager 318, and/or the example consumer profile table 502 may be implemented by one or more circuit(s), programmable processor(s), application specific integrated circuit(s) (ASIC(s)), programmable logic device(s) (PLD(s)) and/or field programmable logic device(s) (FPLD(s)), etc. When any of the appended claims are read to cover a purely software and/or firmware implementation, at least one of the example foodspace manager 112, the example consumer preferences database 114, the example e-commerce services manager 118, the example recipe services manager 120, the example geographic services manager 122, the example social networking services manager 124, the example consumer interface 126, the example product reference library 127, the example social plug-in 138, the example consumer connection manager 302, the example portal manager 304, the example consumer characteristics manager 306, the example attributes database 308, the example recipe scoring engine 310, the example scored recipe database 311, the example recipe searcher 312, the example social message parser 314, the example e-commerce engine 316, the example location manager 318, and/or the example consumer profile table 502 are hereby expressly defined to include a tangible medium such as a memory, a digital versatile disc (DVD), a compact disc (CD), etc. storing the firmware and/or software. Further still, a communication system may include interfaces, data structures, elements, processes and/or devices instead of, or in addition to, those illustrated in FIGS. 1-5 and/or may include more than one of any or all of the illustrated interfaces, data structures, elements, processes and/or devices.

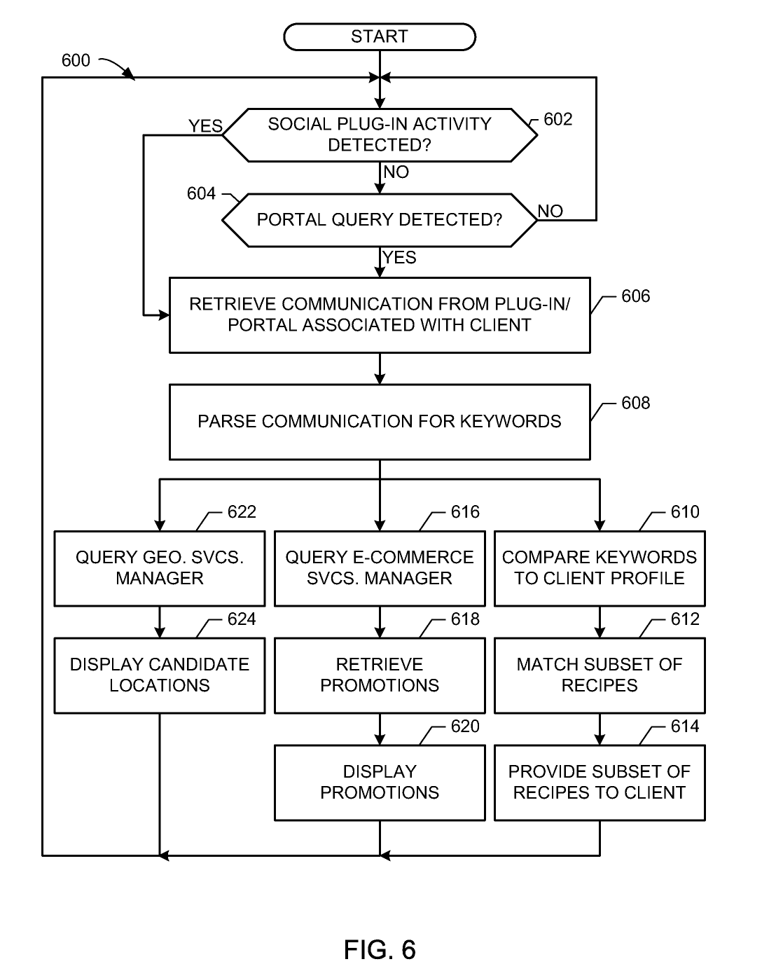

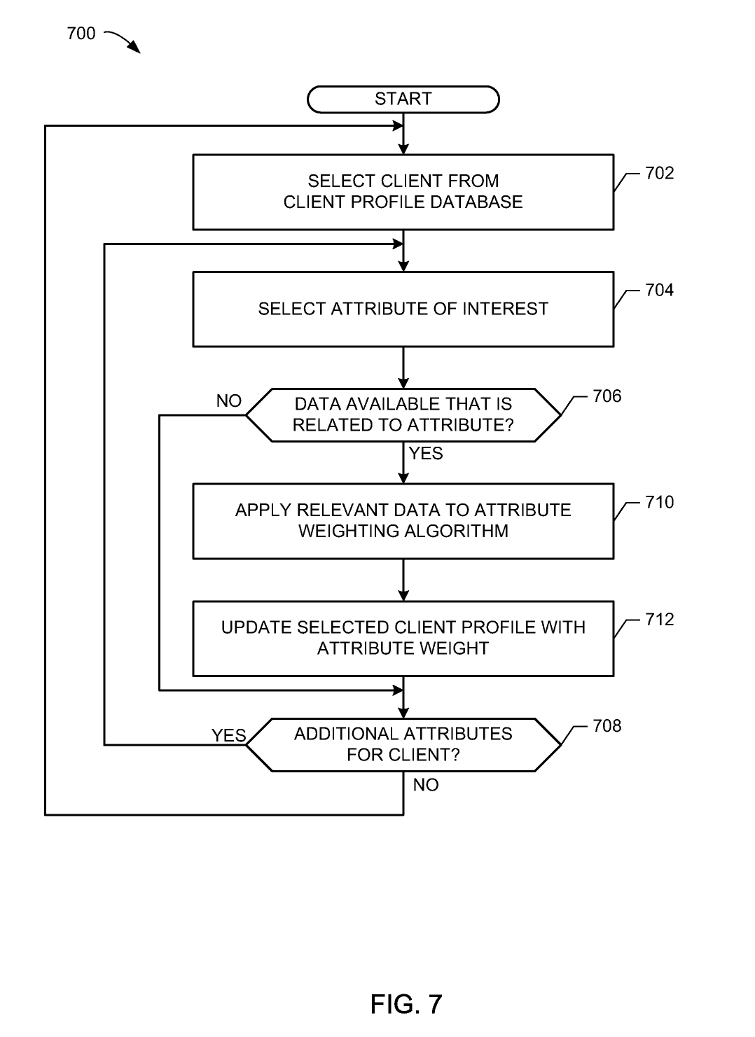

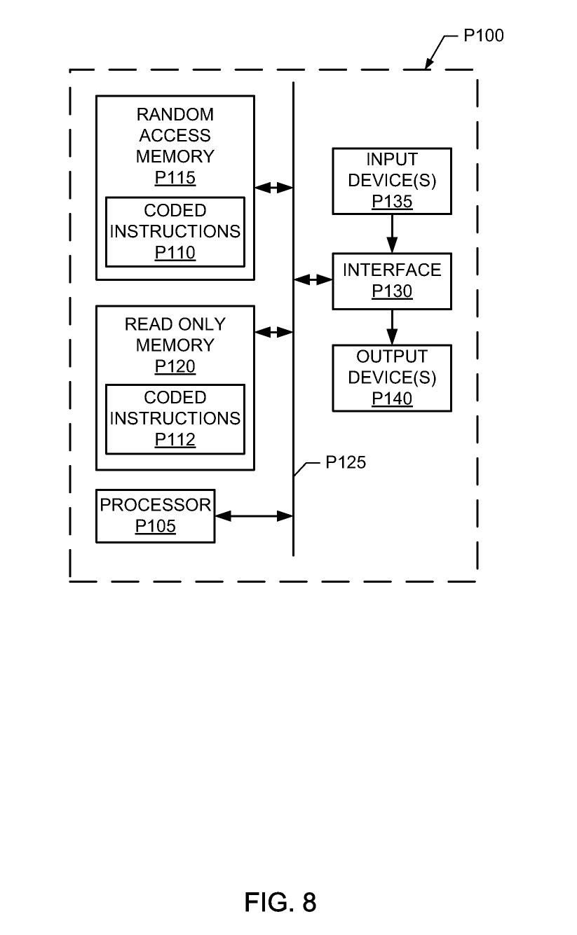

Flowchart representative of example machine readable instructions for implementing the example system 100 of FIGS. 1-5 are shown in FIGS. 6 and 7. In this example, the machine readable instructions comprise a program for execution by a processor such as the processor 1012 shown in the example computer 1000 discussed below in connection with FIG. 8. The program may be embodied in software stored on a computer readable medium such as a CD-ROM, a floppy disk, a hard drive, a digital versatile disk (DVD), or a memory associated with the processor 1012, but the entire program and/or parts thereof could alternatively be executed by a device other than the processor 1012 and/or embodied in firmware or dedicated hardware. Further, although the example program is described with reference to the flowcharts illustrated in FIGS. 6 and 7, many other methods of implementing the example system 100 may alternatively be used. For example, the order of execution of the blocks may be changed, and/or some of the blocks described may be changed, eliminated, or combined.

As mentioned above, the example processes of FIGS. 6 and 7 may be implemented using coded instructions (e.g., computer readable instructions) stored on a tangible computer readable medium such as a hard disk drive, a flash memory, a read-only memory (ROM), a compact disk (CD), a digital versatile disk (DVD), a cache, a random-access memory (RAM) and/or any other storage media in which information is stored for any duration (e.g., for extended time periods, permanently, brief instances, for temporarily buffering, and/or for caching of the information). As used herein, the term tangible computer readable medium is expressly defined to include any type of computer readable storage and to exclude propagating signals. Additionally or alternatively, the example processes of FIGS. 6 and 7 may be implemented using coded instructions (e.g., computer readable instructions) stored on a non-transitory computer readable medium such as a hard disk drive, a flash memory, a read-only memory, a compact disk, a digital versatile disk, a cache, a random-access memory and/or any other storage media in which information is stored for any duration (e.g., for extended time periods, permanently, brief instances, for temporarily buffering, and/or for caching of the information). As used herein, the term non-transitory computer readable medium is expressly defined to include any type of computer readable medium and to exclude propagating signals.

The example process 600 of FIG. 6 includes monitoring one or more social plug-in applications 138 associated with one or more social networking services (block 602). Each plug-in 138 may be installed and/or otherwise invoked by the consumer through a profile or permissions associated with the one or more social networking services (e.g.,) Facebook°. For example, Facebook® encourages application development to operate with its network and provides guides to develop such applications using JavaScript, Python and/or other PHP languages. If the example consumer connection manager 302 does not detect any communication activity associated with the social plug-in 138, the consumer connection manager 302 determines whether communication activity may be occurring via the consumer interface 126, such as via a portal 200 on the consumer's wireless telephone 102 or PC 104 (block 604). In the event that the example consumer connection manager 302 does not detect any communication activity, the example process 600 continues to monitor for communication activity. However, if either form of communication is detected (block 602 or block 604), the example consumer connection manager 302 retrieves such communications from the plug-in 138 and/or the consumer interface 126 (block 606). The example message parser 314 parses the retrieved communications and extracts keywords related to food by comparing the keywords of the communication to a keyword dictionary (block 608).

In an effort to obtain data for the consumer in the shortest amount of time, the example process 600 of FIG. 6 may divide in at least three separate directions, all of which may proceed simultaneously. In some examples, the example processes may alternatively be performed serially or in any other suitable manner In a first direction, the example process 600 compares the parsed keywords to the consumer profile (block 610) and matches a subset of recipes from the scored recipe database 311 based on a degree of similarity between the profile and the keyword(s) received (block 612). The subset of recipes may be made available to the consumer via the portal 200 and/or as a display on one or more social networking sites with which the consumer participates via the example social plug-in application 138 (block 614).

In a second direction, the example process 600 uses the parsed keyword(s) to generate a query to the e-commerce services manager 118 (block 616) and retrieves any promotion(s) available based on the keyword(s). For example, if the keyword included the word “chicken,” then the example e-commerce engine 316 queries the e-commerce services manager 118 for available promotions associated with chicken products (block 618). The e-commerce engine 316 and/or the e-commerce services manager 118 may identify to third party clients 128 that the query is originating from a user of the example system 100, thereby increasing the consumer's bargaining power to obtain a better promotion in view of the fact that each of the third party client(s) 128 knows that the consumer will be presented with a plethora of competitive choices. Additionally, each third party client 128 knows that the consumer is likely to make their decision during the near future. Any promotional discounts made available by the retailers 130 and/or merchants 132 are displayed to the consumer on the example portal 200 and/or within the social networking application via the social plug-in 138 (block 620). Without limitation, the second direction may occur after block 614 so that, for example, the consumer may retrieve one or more promotions associated with the subset of recipes.

In a third direction, the example process 600 uses the parsed keyword(s) from communications (block 608), recipes (block 614), or promotions (block 618) to generate a query to the geographic services manager 122 via the example location manager 318 (block 622). Additionally or alternatively, the example location manager 318 may constrain the location results returned to the consumer by also providing the consumer's current location information (e.g., a zip code, latitude/longitude coordinates provided by a wireless device, etc.) and/or location information associated with manufacturers and/or retailers that are currently offering promotions associated with the parsed keyword(s). Such location information may be displayed to the consumer via the example portal 200 and/or within the social networking application via the social plug-in 138 (block 624).

The example process 700 of FIG. 7 allows the example foodspace manager 112 to update one or more consumer profiles. In the illustrated example of FIG. 7, the consumer characteristics manager 306 selects a consumer of interest from the example consumer profiles database 114 (block 702). As described above, each consumer may be characterized based on any number of attributes, such as attributes related to food. The example consumer characteristics manager 306 queries the example attributes database 308 for an attribute of interest (block 704), such as an attribute related to vegetable preferences, fruit preferences, recipe difficulty preferences, etc. In operation, the example foodspace manager 112 may collect information associated with each consumer, such as recipes that the consumer has received, keywords the consumer has queried, keywords the consumer has used in communication with friends in a social networking application, a frequency count of the number of times a keyword was used by the consumer, a selection of a range, and/or any other types of information provided by the consumer that are indicative of food preferences. Such data may be saved in a memory and/or database for later use and/or configuration of the profile for each consumer.

The example consumer characteristics manager 306 determines whether the available data is relevant to the selected attribute of interest (block 706). For example, if the selected attribute of interest under analysis is related to meat preferences, then any available data (e.g., recent keyword queries, recent messaging keywords) related to vegetarian topics may not influence the meat-related attribute(s) (block 706). If so, then control advances to block 708, in which the example consumer characteristics manager 306 determines whether there are remaining attributes for the consumer to evaluate in view of the available data. The remaining attributes, if any, are evaluated beginning at block 704, as described above, otherwise the example process 700 returns to block 702 to select an alternate consumer to evaluate. In other examples, a prolonged lack of used keywords may allow one or more characteristic weighting values to decrease, thereby reflecting a lack of relevance and/or interest by the consumer with respect to that attribute (e.g., meat-related attributes for a vegetarian).

In the event that the available data is relevant to the selected attribute of interest (block 706), then the example consumer characteristics manager 306 applies the relevant data to one or more attribute weighting algorithms (block 710). For example, the attribute weighting algorithm may monitor for a threshold number of instances of a particular keyword in a given time period. If the given time period includes more than the threshold number of keywords used by the consumer, then the corresponding attribute may increase a corresponding characteristic weight by a predetermined amount (e.g., the New York Strip Steak preference attribute increases by 0.5% if the consumer mentions it more than 5 times in a one-hour period). The example consumer characteristics manager 306 updates the consumer profile with the adjusted weighting value (block 712) and then determines whether there are additional attributes to evaluate for the selected consumer (block 708). Without limitation, the example consumer characteristics manager 306 may identify one or more patterns of behavior and adjust one or more characteristic weighting values of each corresponding consumer.

FIG. 8 is a schematic diagram of an example processor platform P100 that may be used and/or programmed to implement any or all of the example foodspace manager 112, the example consumer preferences database 114, the example e-commerce services manager 118, the example recipe services manager 120, the example geographic services manager 122, the example social networking services manager 124, the example consumer interface 126, the example product reference library 128, the example social plug-in 138, the example consumer connection manager 302, the example portal manager 304, the example consumer characteristics manager 306, the example attributes database 308, the example recipe scoring engine 310, the example scored recipe database 311, the example recipe searcher 312, the example social message parser 314, the example e-commerce engine 316, the example location manager 318, and/or the example consumer profile table 502 of FIGS. 1-5. For example, the processor platform P100 can be implemented by one or more general-purpose processors, processor cores, microcontrollers, etc.

The processor platform P100 of the example of FIG. 8 includes at least one general-purpose programmable processor P105. The processor P105 executes coded instructions P110 and/or P112 present in main memory of the processor P105 (for example, within a RAM P115 and/or a ROM P120). The processor P105 may be any type of processing unit, such as a processor core, a processor and/or a microcontroller. The processor P105 may execute, among other things, the example processes of FIGS. 6 and 7 to implement the example methods and apparatus described herein.

The processor P105 is in communication with the main memory (including a ROM P120 and/or the RAM P115) via a bus P125. The RAM P115 may be implemented by dynamic random access memory (DRAM), synchronous dynamic random access memory (SDRAM), and/or any other type of RAM device, and ROM may be implemented by flash memory and/or any other desired type of memory device. Access to the memory P115 and the memory P120 may be controlled by a memory controller (not shown).

The processor platform P100 also includes an interface circuit P130. The interface circuit P130 may be implemented by any type of interface standard, such as an external memory interface, serial port, general-purpose input/output, etc. One or more input devices P135 and one or more output devices P140 are connected to the interface circuit P130.

Although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

1. A method, comprising:
parsing a message posted on a social networking service to extract a keyword by determining which of a plurality of entries relates to food;
querying a recipe service using the keyword as an ingredient to produce a first set of recipes including the ingredient;
comparing each of the first set of recipes to a profile corresponding to a consumer associated with the message to produce a second set of recipes customized to the consumer; and
conveying at least a first one of the second set of recipes to the consumer.

2. A method as defined in claim 1, wherein conveying at least the first one of the second set of recipes to the consumer comprises conveying at least the first one of the second set of recipes to a mobile device.

3. A method as defined in claim 1, further comprising submitting the extracted keyword to a geographic services manager and receiving one or more locations from the geographic services manager at which the ingredient can be obtained.

4. A method as defined in claim 3, further comprising customizing the one or more locations based on a current location of the consumer.

5. A method as defined in claim 4, wherein the current location of the consumer is to be provided by a mobile device that was used to post the message to the social networking service.

6. A method as defined in claim 1, further comprising submitting the extracted keyword to a commerce services manager and receiving information related to one or more promotions related to the ingredient.

7. A method as defined in claim 6, wherein the information related to the one or more promotions related to the ingredient includes one or more manufacturers associated with the one or more promotions, one or more retailers associated with the one or more promotions, one or more restaurants associated with the one or more promotions, one or more food services associated with the one or more promotions, or one or more publisher associated with the one or more promotions.

8. A method as defined in claim 1, further comprising providing a survey to the consumer based on at least the profile corresponding to the consumer.

9. A method as defined in claim 8, further comprising providing one or more incentives for the consumer to participate in the survey.

10. A tangible computer readable medium having instructions stored thereon that, when executed, cause a machine to:
parse a message posted on a social networking service to extract a keyword by determining which of a plurality of entries relates to food;
query a recipe service using the keyword as an ingredient to produce a first set of recipes including the ingredient;
compare each of the first set of recipes to a profile corresponding to a consumer associated with the message to produce a second set of recipes customized to the consumer; and
convey at least a first one of the second set of recipes to the consumer.

11. (canceled)

12. (canceled)

13. (canceled)

14. (canceled)

15. (canceled)

16. (canceled)

17. (canceled)

18. (canceled)

19. A foodspace manager, comprising:
a message parser to parse a message posted on a social networking service to extract a keyword by determining which of a plurality of entries relates to food;
a recipe searcher to receive a first set of recipes from a recipe service in response to a query using the keyword as an ingredient, wherein the recipe searcher is to compare each of the first set of recipes to a profile corresponding to a consumer associated with the message to produce a second set of recipes customized to the consumer; and
a portal manager to convey at least a first one of the second set of recipes to the consumer.

20. A foodspace manager as defined in claim 19, wherein the portal manager is to convey the first one of the second set of recipes to the consumer by displaying the first one of the second set of recipes on an interface executed on a mobile device.

21. A foodspace manager as defined in claim 19, further comprising a location manager to submit the extracted keyword to a geographic services manager and to receive one or more locations from the geographic services manager at which the ingredient can be obtained.

22. A foodspace manager as defined in claim 21, wherein the location manager is to customize the one or more locations based on a current location of the consumer.

23. A foodspace manager as defined in claim 22, wherein the current location of the consumer is to be provided by a mobile device that was used to post the message to the social networking service.

24. A foodspace manager as defined in claim 19, further comprising a commerce engine to submit the extracted keyword to a commerce services manager and to receive information related to one or more promotions related to the ingredient.

25. A foodspace manager as defined in claim 24, wherein the information related to the one or more promotions related to the ingredient includes one or more manufacturers associated with the one or more promotions, one or more retailers associated with the one or more promotions, one or more restaurants associated with the one or more promotions, one or more food services associated with the one or more promotions, or one or more publishers associated with the one or more promotions.

26. A foodspace manager as defined in claim 19, further comprising a survey manager to provide a survey to the consumer based on at least the profile corresponding to the consumer.

27. A foodspace manager as defined in claim 26, wherein the survey manager is to provide one or more incentives for the consumer to participate in the survey.

28. A meal planning and coupon dispensing system, comprising:
a social networking service manager to monitor one or more social networking services via a plug-in application;
a foodspace manager to receive data from the plug-in application and to extract a keyword from the data by determining which portions of the data relate to food;
a recipe services manager to receive the keyword from the foodspace manager as an ingredient to be used in a query of a recipe database, the recipe services manager to provide a first set of recipes to the foodspace manager based on the ingredient,
wherein the foodspace manager is to produce a second set of recipes by comparing each of the first set of recipes with a profile corresponding to a consumer associated with the data, and wherein the foodspace manager is to convey at least a portion of the second set of recipes to the consumer.
